(19) United States
(12) Patent Application Publication
(10) Pub. No.: US 2024/0378615 A1
(43) Pub. Date: Nov. 14, 2024

(54) RISK CALCULATION USING ENTITY GRAPH WITH EDGE WEIGHTS BY CARDINALITY

(71) Applicant: PAYPAL, INC., San Jose, CA (US)

(72) Inventors: Romil Varadkar, Bangalore (IN); Suraj Arulmozhi, Chennai (IN); Ashok Subash, Chennai (IN); Harini Shekar, Chennai (IN); Ashok Srinivas Darsi, Hyderabad (IN); Tanisha Singh, Bengaluru (IN); Logasundari Vinayagam, Fremont, CA (US)

(21) Appl. No.: 18/216,354

(22) Filed: Jun. 29, 2023

(30) Foreign Application Priority Data
May 12, 2023 (IN) 202311033587

(51) Int. Cl. G06Q 20/40

(52) U.S. Cl. CPC G06Q 20/4016

(57) ABSTRACT

A transaction processing method includes receiving data respective of an electronic transaction, the data including an account involved in the transaction and determining an entity graph according to the account. The entity graph includes a plurality of first-order connections, each including a primary node representative of the account, a secondary node representative of a secondary entity, and an edge from the primary node to the secondary node, and a plurality of second-order connections, each including one of the secondary nodes, a tertiary node representative of a tertiary entity, and an edge from the secondary node to the tertiary node. The method includes determining a weight associated with each first-order connection edge based on a quantity of second-order connections associated with the secondary node in the first-order connection, calculating a risk associated with the electronic transaction according to the respective weights, and processing the electronic transaction according to the calculated risk.

### TECHNICAL FIELD

The instant disclosure relates to risk calculation is electronic transaction processing, including risk calculation based on characteristics of a party in the transaction and/or characteristics of similar entities.

### BACKGROUND

Many electronic transactions include accompanying risk, such as a risk of fraud or a risk of a return or other recall or cancellation. Calculating the risk associated with an electronic transaction may assist a transaction processing system in implementing appropriate safeguards or requirements for facilitating the transaction in view of the risk, or in determining not to process a transaction at all because the risk is unacceptably high.

The degree of risk involved in a transaction generally correlates with the outcomes of similar transactions. That is, transactions involving similar sets of circumstances, such as similar parties, similar goods or services, similar payment amounts, etc. may be indicative of the degree of risk of a new transaction.

### BRIEF DESCRIPTION OF THE DRAWINGS

FIG. 1 is a block diagram view of an example system for predicting risk and processing an electronic transaction according to the predicted risk.

FIG. 2 is a diagrammatic view of an example entity graph related to an electronic transaction.

FIG. 3 is an enlarged view of a portion of the example entity graph of FIG. 2.

FIG. 4 is a flow chart illustrating an example method of predicting risk and processing an electronic transaction according to the predicted risk.

FIG. 5 is a sequence diagram illustrating an example high-risk electronic transaction.

FIG. 6 is a sequence diagram illustrating an example low-risk electronic transaction.

FIG. 7 is a sequence diagram illustrating an example high-risk electronic transaction.

FIG. 8 is a block diagram view of an example computing environment.

### DETAILED DESCRIPTION

Graph neural networks (“GNNs”) incorporate a large amount of information from connected nodes that can be used to make predictions. Such information may be very useful in risk prediction because the behavior of similar entities in similar transactions, and the outcomes of those transactions, can be indicative of risk. But GNNs are computationally expensive, and therefore not well-suited to real-time assessment of transactional risk.

Fraud detection and other transaction risk calculation can be improved by using features propagated through clusters of similar accounts, similar to the way in which GNNs pass information from node to node. It is possible that transaction accounts that are connected by various edge constraints such as location, transaction pattern, history of edits/changes in details, history of transacting with similar parties or at similar locations, with similar transaction amounts and so on, could have similar behavior with respect to fraud. Features based on message passing on weighed edges can help identify such accounts in a cluster together by propagating information through weighed edges of a graph of those accounts.

The instant disclosure provides a message passing framework of nodes and edges, which allow propagation of information across connected nodes, weighed by the edges. Similar nodes may be be connected to each other through various edge constraints and the degree of similarity may be directly proportional to the number of connected edges. Edges may be weighed to eliminate extreme dilution through very common edge constraints. An exponential importance may be assigned to edges with low cardinality.

The instant disclosure includes an approach that effectively incorporates the message passing component of graph neural networks into simpler model processing by deriving edge weights that help extract features that help propagate cluster behavior. These features can be consumed and trained in traditional machine learning algorithms and hence helps white-boxing the cluster-based dependencies through message passing features We propose to introduce multiple relationships that can connect nodes and weigh each relationship based on edge weights based on inverse cardinality, and/or edge weights based on a weight matrix learned through supervised algorithms. This approach captures spatial dependencies between nodes, helps differentiate between different relationships by assigning a weight to each edge, helps white-box dependencies between nodes by creating features which can be consumed by traditional algorithms, and eliminates the need for complex Neural network architectures and hence is platform independent and more computationally efficient.

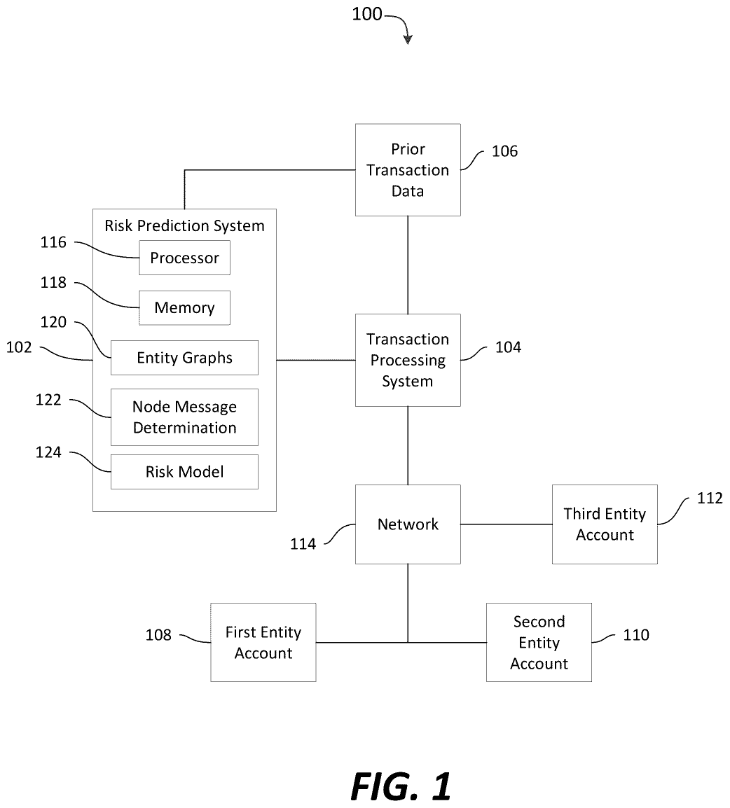

Referring to the drawings, wherein like reference numerals refer to the same or similar features in the various views, FIG. 1 is a block diagram view of an example system 100 for predicting risk and processing an electronic transaction according to the predicted risk. The system 100 may include a risk prediction system 102, a transaction processing system 104, a source of prior transaction data 106, and a first entity account 108, a second entity account 110, and a third entity account 112. The first entity account 108, second entity account 110, third entity account 112, and transaction processing system 104 may be in electronic communication with one another through a network 114.

The first, second, and third entity accounts 108, 110, 112 may be accounts associated with parties to an electronic transaction, such as a file exchange, a real estate transaction, a payment transaction, etc. For example, the first entity account 108 may be an account associated with a provider in the transaction (e.g., a provider of a file, a provider of a piece of real estate, or a provider of a payment); the second entity account 110 may be an account associated with a recipient in the transaction (e.g., a recipient of a file, a recipient of a piece of real estate, or a recipient of a payment); and the third entity account 112 may be an account associated with a facilitating party to the transaction (e.g., an account associated with an escrow agent for a file or a piece of real estate, or an account associated with a payment form, such as a credit card). The transaction processing system 104 may process the transaction by mediating the flow of data among the first, second, and third entity accounts 108, 110, 112.

The risk prediction system 102 may include a processor 116 and a non-transitory, computer-readable memory 118 storing instructions that, when executed by the processor 116, cause the risk prediction system 102 to perform one or more of the steps, processes, methods, operations, etc. described herein with respect to the risk prediction system 102. The risk prediction system 102 may include one or more functional modules embodied in the memory. The functional modules may include an entity graph module 120, a node message determination module 122, and a risk model module 124.

Generally, the risk prediction system 102 may predict a risk level of a transaction submitted to the transaction processing system 104 by one or more of the entity accounts 108, 110, 112. Based on the risk level predicted by the risk prediction system 102, the transaction processing system 104 may process the submitted transaction. For example, the transaction processing system 104 may process the entire transaction, process only a portion of the transaction, delay processing of one or more portions of the transaction, reject the transaction, etc., based on the predicted risk level.

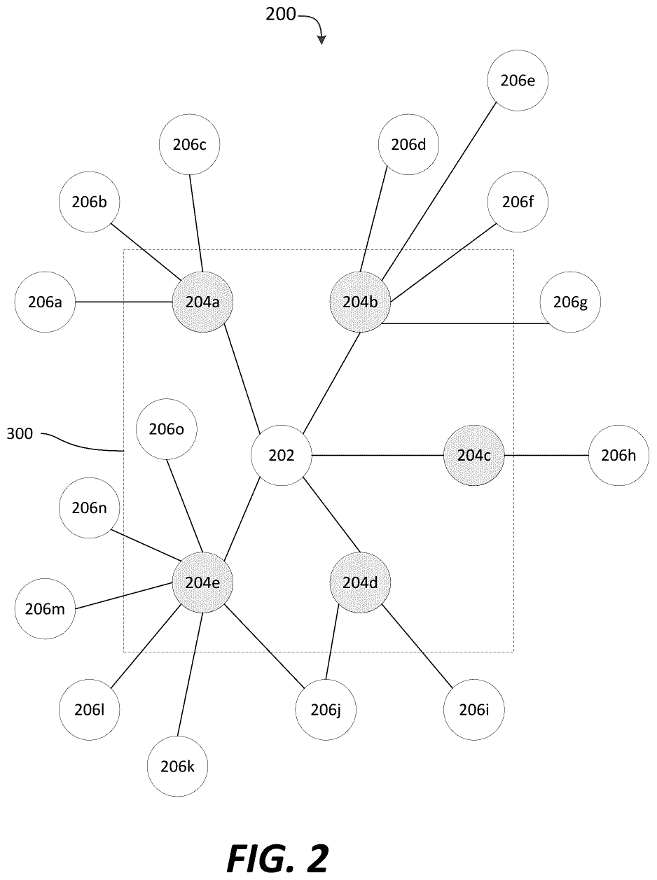

The entity graph module 120 may build and/or store one or more entity graphs. Each entity graph may include a plurality of nodes connected to each other by a plurality of edges. For example, FIG. 2 illustrates an example entity graph 200 having twenty-one nodes 202, 204a-e, 206a-o (which may be referred to collectively as nodes 202, 204, 206 or individually as a node 202, 204, 206) connected by respective edges. Each node 202, 204, 206 may be representative of an account and/or an entity, and edges that connect two nodes indicate a common characteristic of the two connected nodes. For example, nodes 202, 204, 206 may be connected because of (e.g., edges may represent) common transactional activity, such as a transaction involving the accounts represented by two nodes or transactions by the accounts represented by the two nodes with a common third party. In another example, nodes 202, 204, 206 may be connected because of non-transactional relationships between the entities represented by the nodes, such as a geographic relationship, a social media connection, a business relationship (e.g., corporate affiliates), common personal traits (e.g., hobbies or interests), common professional traits (e.g., skills or education), etc.

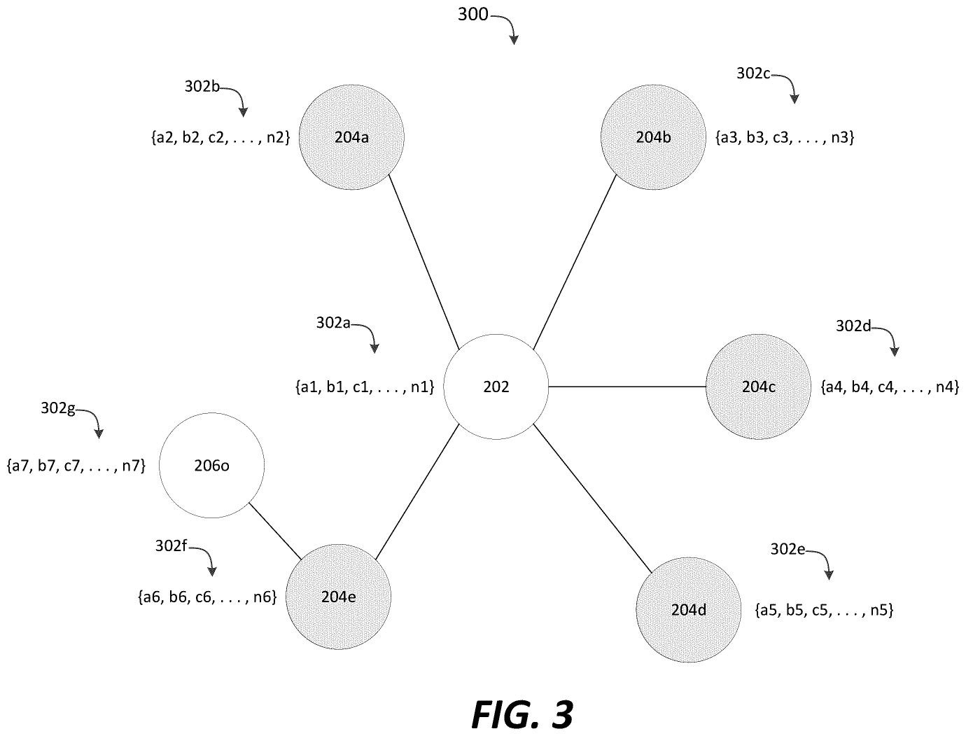

FIG. 3 illustrates a portion 300 of the example entity graph 200 of FIG. 2. As shown in FIG. 3, each node 202, 204, 206 may have an associated feature vector 302. That is, node 202 has an associated feature vector 302a, node 204a has an associated feature vector 302b, and so on. Each feature vector 302 may include a plurality of values respective of a plurality of features of the account and/or entity represented by the node 202, 204, 206. For example, feature vector 302a includes a vector of first values {a1, b1, c1, . . . , n1} for features a, b, c, . . . , n. Similarly feature vector 302b includes a vector of second values {a2, b2, c2, . . . , n2} for features a, b, c, . . . , n. The features a, b, c, . . . , n may be or may include any characteristic of the entity or account represented by the associated node 202, 204, 206. For example, features may include demographic or bibliographic information of the entity or account (e.g., age of an account, location of an account owner, etc.), a quantity of different types of transactions in which the entity or account has been involved, a quantity of different transaction outcomes (e.g., transaction successful, transaction cancelled, transaction recalled, etc.) in which the entity or account has been involved, a temporal or seasonal aspect of one or more transactions in which the entity or account has been involved (e.g., day of week, hour of day, quarter of year), and the like.

Referring again to FIG. 1, the entity graph module 120 may build or amend entity graphs based on the prior transaction data 106, which may include electronic transactions processed by the transaction processing system 104 and/or transactions involving the first, second, or third entity accounts 108, 110, 112 on publicly-accessible platforms or that are otherwise accessible to the transaction processing system 104. Additionally or alternatively, the entity graph module 120 may build or amend entity graphs based on non-transactional relationships between entities and/or accounts, such as social media relationships, geographic relationships, business relationships, personal relationships (e.g., family members), etc. Once built, entity graphs may be stored by the entity graph module 120 for later review and access to calculate risks for transactions.

The entity graph module 120 may build and/or store multiple entity graphs respective of the same underlying set of entities, in some embodiments. For example, multiple entity graphs may be built and stored, with different relationships or relationship types as the basis for the edges in one graph relative to other graphs. In another example, multiple entity graphs may be built and stored, with different temporal contexts as the basis for including or not including an entity in one graph relative to another (e.g., one graph for accounts involved in electronic transactions on a Tuesday between 10 am and 2 pm, a second graph for accounts involved in electronic transactions on a Friday between 7 pm and 11 pm, and so on). In another example, multiple entity graphs may be built and stored, with different categorical contexts as the basis for including or not including an entity in one graph relative to another (e.g., one graph for accounts involved in electronic transactions for a first type of file or a first type of buyer or a first type of seller, a second graph for accounts involved in electronic transactions for a second type of file or a second type of buyer or a second type of seller, etc.).

In some embodiments, the entity graph module 120 may update or amend one or more entity graphs as additional transactions are performed by the transaction processing system 104 and/or otherwise become known to the risk prediction system 102. For example, if an account (e.g., the account represented by node 204a) performs a transaction with another account (e.g., the account represented by node 206d) for the first time, the entity graph module may amend the entity graph 200 by adding an edge from node 204a to node 206d, as shown by the dotted line in FIG. 2.

Further, in some embodiments, the entity graph module 120 may update or amend one or more feature vectors associated with one or more nodes 202, 204, 206 as additional transactions are performed by the transaction processing system 104 and/or otherwise become known to the risk prediction system 102. For example, in response to a transaction of a specific category being performed by the entity represented by node 204b, the feature vector value c3 that represents the number of transactions within that category may be amended by the entity graph module 120.

The node message determination module 122 may determine, based on a requested transaction, an entity graph or a portion of an entity graph that is relevant to the requested transaction. For example, the node message determination module 122 may retrieve the entity graph associated with the context of the requested transaction (e.g., the entity graph specific to the categorical or temporal context of the requested transaction). Further, the node message determination module may retrieve or isolate a portion of the retrieved entity graph that includes one or more of the entity accounts 108, 110, 112 involved in the requested transaction and a predetermined portion of the entity graph around the one or more of the entity accounts 108, 110, 112 involved in the requested transaction.

Referring to FIGS. 1 and 2, a requested transaction transmitted to the transaction processing system 102 may involve the third entity account 112, and the third entity account may be represented in the relevant entity graph by node 202. In response to the requested transaction, the node message determination module 122 may locate the node 202 and one or more layers of connections to the node 202. For example, in an embodiment, the node message determination module 122 may determine nodes within two orders of connection of the node 202, as shown in FIG. 2, in which nodes 204a-204e are first-order connections relative to the node 202, and nodes 206a-206f are second-order connections relative to the node 202. First order connection nodes may also be referred to herein as “secondary nodes,” and second-order connected nodes may also be referred to herein as “tertiary nodes.” Accordingly, the graph 200 includes a plurality of first-order connections, each first-order connection including the primary node 202 representative of the account in the transaction, a respective secondary node 204 representative of a respective secondary entity, and a respective edge from the primary node 202 to the secondary node 204. The graph 200 also includes a plurality of second-order connections, each second-order connection including one of the secondary nodes 204, a respective tertiary node 206 representative of a respective tertiary entity, and a respective edge from the secondary node 204 to the tertiary node 206. A graph or graph portion retrieved by the node message determination module 122 may also include third-order connections, fourth-order connections, and so on.

The node message determination module 122 may also determine weights to be assigned to each node in the retrieved graph or graph portion for use in the risk calculation. The weight assigned to a particular node may be determined based on a cardinality of that node, in some embodiments. For example, the weight assigned to a node may be determined based on the quantity of edges connected to that node in the graph or graph portion. In some embodiments, the weight assigned to a node may be inversely proportional to the quantity of edges connected to the node. Referring to FIG. 2, node 204b has four second-order connections (nodes 206d, 206e, 206f, and 206g), and node 204c has one second-order connection (node 206h). Accordingly, the weight assigned to node 204b may be different from the weight assigned to node 204c. Where weight is inversely proportional to cardinality, the weight assigned to node 204b may be lower than the weight assigned to node 204c.

The node message determination module 122 may also retrieve feature vectors, or portions of feature vectors, of nodes connected to the node representative of an account involved in a transaction. Those feature vectors, or feature vector portions, may be used in connection with determined weights to predict a risk associated with a transaction, an entity, etc. For example, based on a transaction involving node 202, the node message determination module 122 may retrieve feature vectors or feature vector portions respective of nodes 204a-e and/or nodes 206a-o.

The risk model module 124 may calculate a risk associated with a transaction or an entity based, in part, on the values in the feature vectors retrieved by the node message determination module 122 and the weights calculated by the node message determination module 122. For example, the risk model module may be or may include a regression model that is applied to data respective of one or more entities or transactions in question, such as one or more features of an account, a time of the transaction, a quantity of the transaction, a category of the transaction, a characteristic of a providing user in the transaction, or a characteristic of a receiving user in the transaction. Each of these data types that may be considered by the risk model module 124 (e.g., input to a risk model, such as a regression model) is explained in greater detail below.

One or more features of an account may be considered in a risk calculation by the risk model module 124. For example, an age or location associated with an account, the types of transactions in which the account engages (e.g., times, amounts, categories, etc. of those transactions), or other account information respective of an account set forth herein.

One or more characteristics of a providing user in a transaction may also be considered in a risk calculation by the risk model module 124, where the risk calculation is for a transaction. A providing user in a transaction may be, for example, a provider of a file transferred in the transaction, a piece of real estate transferred in the transaction, a payment transferred in the transaction, etc. The one or more characteristics may include, for example, demographic information of the user, the types of transactions typically entered into by the user, and the like.

One or more characteristics of a receiving user in a transaction may also be considered in a risk calculation by the risk model module 124, where the risk calculation is for a transaction. A receiving user in a transaction may be, for example, a recipient of a file transferred in the transaction, a piece of real estate transferred in the transaction, a payment transferred in the transaction, etc. The one or more characteristics may include, for example, demographic information of the user, the types of transactions typically entered into by the user, and the like.

Where a risk associated with a specific entity, rather than a specific transaction, is to be calculated by the risk model module 124, the above-noted characteristics of an account, a providing user, or a receiving user may be considered with respect to the specific entity.

The risk model module 124 may consider a time of the transaction when determining a risk of the transaction, in some embodiments. For example, a day of the week, day of the month, day of the year, month of the year, etc., may be considered. Similarly, a time of the day may be considered.

The risk model module 124 may consider a quantity of the transaction, in some embodiments. For example, a quantity of files or size of file exchanged, a quantity or size of real estate, or a quantity of a payment exchanged in the transaction may be considered.

Still further, the risk model module 124 may consider a category of the transaction. The category of the transaction may be or may include, for example, a type of file, a type of real estate parcel, or a type of good or service exchanged in the transaction. In other examples, the category of the transaction may be or may include a category of a party to the transaction, such as a merchant category or a buyer category.

As noted above, certain features considered by the risk model module 124 (e.g., input to a risk model, such as a regression model) may be determined from feature vectors associated with nodes of an entity graph, which nodes may also be associated with weights. For example, a feature vector value F1 associated with an account or entity node in question A may be modified based on feature vector values of connected nodes B and C, with the values from all nodes weighted by cardinality. An example of weighing the influence of two connected nodes B and C on the node in question A is set forth in equation (1) below:

$$F 1 = α A 1 + \frac{B 1}{\sqrt{n 1 n 2}} + \frac{C 1}{\sqrt{n 1 n 3}} \qquad ( Eq . 1 )$$

where α is a scalar, A1 is the value from the original feature vector for node A, B1 is the value from the feature vector for node B, and C1 is the value from the original feature vector for node C, and n1, n2, and n3 are the cardinality of nodes A, B, and C, respectively. Accordingly, the relative contributions of nodes B and C is inversely proportional to their cardinality. The value of a may be selected to determine the scale or degree by which the value of F1 may be influenced by B1 and C1, with a higher value of a resulting in less influence of B1 and C1.

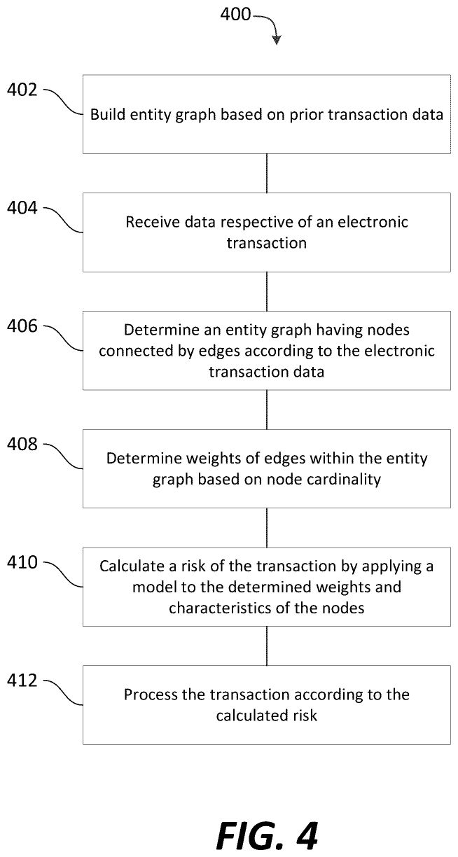

In operation, a request for a transaction involving the first account entity 108, the second account entity 110, and the third account entity 112 may be submitted by the first account entity 108 (e.g., by a computing system operated by or affiliated with the first account entity 108). The transaction may be, for example, a transaction in which the first account entity is a receiving entity, the second account entity is a providing entity, and the third account entity is a facilitating entity. In response, the transaction processing system 104 may process one or more portions of the submitted transaction. The transaction processing system 104 may also submit the transaction to the risk prediction system 102 to determine a risk associated with the transaction. To determine the risk, the node message determination module 122 may retrieve an entity graph or entity graph portion centered on a relevant entity involved in the transaction, such as the third account entity 112, for example. The node message determination module may determine a plurality of nodes connected to the third entity account 112 in the retrieved graph (e.g., as first-order connections, second-order connections, and so on) and also retrieve feature vectors, or portions of feature vectors, associated with those nodes, and may determine weights of each of those nodes. The entity graph may have been previously built and stored by the entity graph module 120. Based on the retrieved feature vectors, determined weights, and/or additional information associated with the transaction or parties to the transaction, the risk mode module 124 may calculate a predicted risk of the transaction. The transaction processing system 104 may then process the transaction according to the predicted risk. Examples of processing a transaction according to a predicted risk are set forth below with respect to FIGS. 4, 5, and 6.

In addition to risk associated with a specific transaction, the risk prediction system 102 may also find use in predicting risk associated with entities or accounts. For example, the operations of the entity graph module 120, node message determination module 122, and/or risk model module 124 may be applied to assess the risk of a particular account. Based on the determined risk of the account, certain safeguards may associated with the account (e.g., if the account is high-risk). For example, an account may be required to provide collateral (e.g., dedicated computing resources, financial resources, etc.) before being permitted to enter into a transaction, or a transaction may be executed in a particular fashion (e.g., without certain aspects of the transaction being completed until a certain passage of time), etc.

The risk prediction system 102 may be implemented in connection with a payment system, in some embodiments. For example, the transaction processing system 104 may be or may include a payment system for facilitating payments from the second entity account 110 to the first entity account 108 using a form of payment associated with the third entity account 112. Accordingly, in some embodiments, the transaction processing system 104 may execute one or more aspects of a payment from the second entity account 110 to the first entity account 108 based on the calculated risk, and may execute, delay, or decline another one or more aspects of the payment based on the calculated risk.

In some embodiments, the risk prediction system 102 may be provided as a portion or functionality of the transaction processing system 104. In other embodiments, the risk prediction system 102 may be provided on independent computing resources from the transaction processing system 104.

By using values of feature vectors from connected nodes in an entity graph as input to a regression model or other simple model, a risk calculation according to the present disclosure may utilize the message passing aspects of a graph neural network, without requiring the computational load of executing graph neural network. As a result, a risk calculation according to the present disclosure can execute substantially in real time to process transactions without introducing significant delay, which would not be computationally feasible using a full GNN approach. Further, by incorporating message passing aspects into a simple model, calculating risk according to the present disclosure may outperform risk calculations according to known simple models.

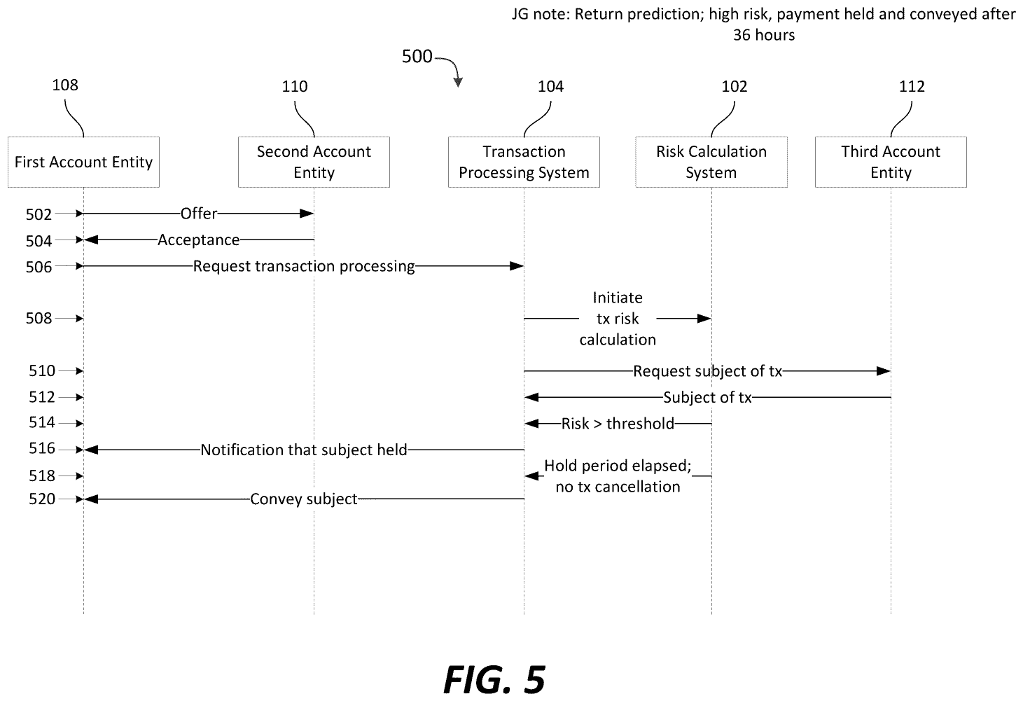

Example uses cases of the system 100 will be described below with respect to FIGS. 4-7. First, with respect to FIG. 4, a general use and operation process for the system 100 will be described. Then, with respect to FIGS. 5-7, specific transaction types, and how the system 100 may find use with those transaction types, will be described.

FIG. 4 is a flow chart illustrating an example method 400 of predicting risk and processing an electronic transaction according to the predicted risk. The method 400, or one or more portions of the method 400, may be performed by the risk prediction system 102 and/or the transaction processing system 104, in some embodiments.

The method 400 may include, at block 402, building one or more entity graphs based on prior transaction data. An entity graph may be created by creating an edge for each relevant entity or account and adding an edge connecting nodes having relevant relationships. For example, as noted above, edges may be added between nodes that have shared a common transaction. Building entity graphs at block 402 may also include basing the entity graphs on non-transactional information. For example, edges may be created to connect nodes that have a non-transactional relationship, such as a social media relationship, a corporate relationship, a geographic relationship, a familial relationship, etc.

In some embodiments, block 402 may include creating a plurality of entity graphs, each specific to a particular context. For example, a first entity graph may be built for a specific combination of a particular day of the week, a particular time of day, and a particular category of transaction. For example, all accounts that have engaged in a transaction within that specific context (that is, nodes representative of those accounts) may be included in the context-specific entity graph, with relationships determined as noted above. A second entity graph may be built for a different context (e.g., a different combination of day of week, time of day, and transaction category), a third entity graph for a third context, and so on. Factors that may be considered for the context of an entity graph includes, for example, a time of the transaction (e.g., month, day of the week, time of the day, etc.), a quantity of the transaction (e.g., a quantity of goods, services, real estate, currency, etc. exchanged in the transaction), and/or a category of the transaction (e.g., a category of goods, services, real estate, merchant, buyer, etc.).

The method 400 may further include, at block 404, receiving data respective of an electronic transaction. The data may be received from one or more of the parties involved in the transaction, in some embodiments. The data may include, for example, one or more of an account identifier respective of one or more accounts involved in the transaction, such as a providing party account, a receiving party account, or a facilitating party account. For example, the facilitating party account may be a credit card account, and the credit card may have been swiped or otherwise scanned at a point of sale, and thus the electronic transaction data may be received from the point of sale system and may include the credit card account information. In another example, the providing party may be a provider of a file and the receiving party may be the recipient of a file. In such an example, the received data may include an identity of the providing party and/or receiving party, an account identifier of the providing party account and/or receiving party account, or other identifier of the party or the party's account. Still further, the received transaction data may include non-party aspects of the transaction, such as one or more quantities or goods, services, files, real estate, currency, etc. exchanged in the transaction. The received transaction data may further include contextual information regarding the transaction, such as a month, week, day, time, location, etc. The received transaction data may further include categorical information regarding the transaction, such as a category of one or more of the parties, or a category of one or more of the goods, services, files, real estate, etc. exchanged in the transaction.

The method 400 may further include, at block 406, determining an entity graph according to the received electronic transaction data. The determined entity graph may be one of the entity graphs built at block 402, and thus may include a plurality of nodes connected by a plurality of edges. Block 402 may include retrieving a particular entity graph from a set of entity graphs according to contextual information in the received transaction information. For example, block 402 may include retrieving an entity graph for a particular combination of day, time, and transaction quantity (e.g., quantity of currency) from among many entity graphs, each specific to a respective combination of day, time, and transaction quantity. In other embodiments, entity graphs may be provided for other combinations of contextual factors, and those contextual factors from the transaction in question may be used to select a particular entity graph.

Block 406 may further include identifying a particular portion of the retrieved entity graph according to entity or account information in the received transaction data. For example, where the received transaction data includes account information respective of a payment account, a node in the entity graph associated with that payment account may be designated as a primary node, and nodes connected to that primary node (e.g., secondary nodes, tertiary nodes, and so on) in the graph may be identified.

The method 400 may further include, at block 408, determining respective weights of a plurality of edges within the determined entity graph based on the cardinality of the connected nodes. Block 408 may include, for example, determining a respective weight to associate with the edge connecting each secondary node to the primary node based on a respective quantity of connections of each secondary node. The weight associated with an edge or node may be inversely proportional to the cardinality of the node, in some embodiments.

The method 400 may further include, at block 410, calculating a risk of the transaction by applying a model to the determined weights in combination with characteristics of the connected nodes. Each of the identified nodes in the entity graph (e.g., the primary node, the secondary nodes, the tertiary nodes, etc.) may be associated with a set of features of the entity or account represented by the node. The features, and values respective of those features, may be embodied in a respective feature vector of each node. Block 410 may include applying a model to the feature values of one or more nodes. For example, in some embodiments, feature values of the primary node and one or more connected nodes (e.g., one or more secondary nodes) may be input to the model. The values of one or more features may be weighted in their input to the model based on the cardinality of the associated node, in some embodiments (e.g., as set forth herein with respect to equation (1)). Some feature values may be unweighted, or weighted according to a factor other than cardinality, in some embodiments. Accordingly, block 410 may include applying a model to a combination of feature values from a plurality of nodes, with some feature values weighted by cardinality, and some feature values not weighted by cardinality.

The model applied at block 410 may be a regression model or other model that imposes a relatively low demand on computing resources on a system performing the method 400, such that blocks 404-410 of the method 400 can be performed substantially in real time in response to a transaction being initiated.

The method 400 may further include, at block 412, processing the transaction according to the calculated risk. Examples of processing the transaction according to the calculated risk are described below with respect to FIGS. 5-7. Briefly, block 412 may include comparing the calculated risk to a threshold to determine if the transaction risk exceeds the threshold (and is therefore high-risk) or does not exceed the threshold (and is therefore low-risk). Block 412 may further include processing the entire transaction where the calculated risk indicates that the transaction is low risk, and processing only part of the transaction or rejecting the transaction where the calculated risk indicates that the transaction is high risk.

FIG. 5 is a sequence diagram illustrating an example high-risk electronic transaction process 500. The process 500 may include, at operation 502, a first account entity 108 transmitting or otherwise providing an offer for a transaction to a second account entity 110 and, at operation 504, the second account entity 110 transmitting or otherwise providing an acceptance to the first account entity 108.

The process 500 may further include, at operation 506, the first account entity 108 transmitting, and the transaction processing system 104 receiving, a request to process the transaction. The request may be transmitted by a computing system operated by or on behalf of the first account entity 108. For example, the request may be transmitted by a point of sale system. The request may include information respective of the transaction, such as identification of the first account or the second account, identification of a third account 112, such as a payment account or an escrow account provided by the second entity, contextual information respective of the transaction, and/or quantitative information respective of the transaction.

The process 500 may further include, at operation 508, the transaction processing system 104 initiating, via the risk calculation system 102, a risk calculation respective of the transaction. The risk may be calculated according to the data received in the transaction request, as described herein.

The process 500 may further include, at operation 510, the transaction processing system 104 requesting the subject of the transaction from the third account and, at operation 512, the third account transmitting the subject of the transaction to the transaction processing system. In some embodiments, the third account may transmit a payment, file, or other aspect of the transaction to the transaction processing system 104.

At operation 514, the process 500 may include the risk calculation system 102 determining that a risk of the transaction exceeds a threshold and informing the transaction processing system 104 that the risk exceeds the threshold. At operation 516, the transaction processing system 104 may inform the first account entity 108 that the subject of the transaction, received by the transaction processing system 104, is being held by the transaction processing system 104 pending one or more events, such as the passage of a predetermined period of time without the transaction being recalled or otherwise cancelled by the second account entity 110.

At operation 518, the predetermined period of time elapses without the transaction being recalled or otherwise cancelled by the second account entity 110 and, in response, at operation 520, the transaction processing system 104 may transmit the subject of the transaction to the first account entity 108.

In an example of the process 500, the transaction may be a purchase or other payment transaction in which the second account entity (purchaser) conveys a payment to the first account entity (merchant), with the third account being the payment account, such as a credit card account. In response to determining that the transaction risk-which may represent, for example, a risk that the purchaser will initiate a return on the transaction-the transaction processing system 104 may hold payment to the merchant until a predetermined period of time elapses without a return being initiated. After the predetermined period of time without a return, the transaction processing system 104 may convey the payment to the merchant.

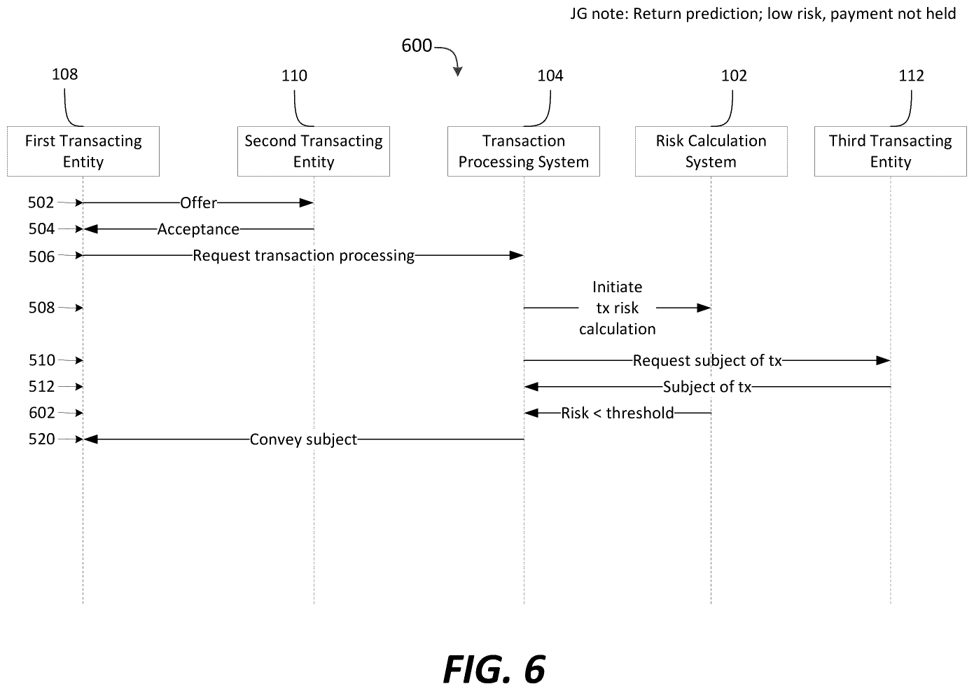

FIG. 6 is a sequence diagram illustrating an example low-risk electronic transaction process 600. The process 600 may include operations 502, 504, 506, 508, 510, 512 described above. At operation 602, the process 600 may include the risk calculation system 102 determining that a risk of the transaction does not exceed a threshold and, in response, at operation 520, immediately conveying the subject of the transaction to the first account entity 108. In contract with the process 500, in which the subject is held by the transaction processing system 104 in response to the risk exceeding the threshold, the transaction processing system 104 in process 600 immediately conveys the transaction subject in response to the calculated risk not exceeding the threshold.

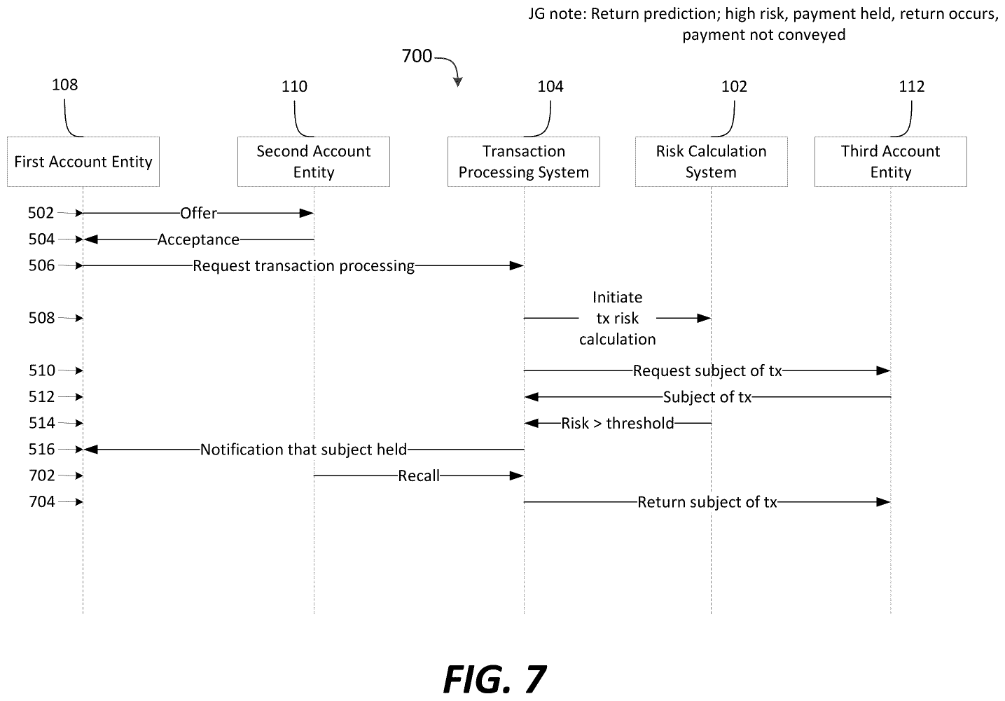

FIG. 7 is a sequence diagram illustrating an example high-risk electronic transaction process 700. The process 700 may include operations 502, 504, 506, 508, 510, 512, 514, 516 described above. At operation 702, the second account entity 110 initiates a recall of the transaction and the transaction processing system 104 receives a notification of the recall. In response, at operation 704, the transaction processing system 104 returns the subject of the transaction to the third account entity 112.

FIG. 7 illustrates a technical benefit of the approach to transaction processing set forth in this disclosure. Specifically, in known transaction processing, the subject of the transaction would have been conveyed from the transaction processing system to the first account entity and, after the recall, the first account entity would have had to re-convey the subject to the transaction processing system. By eliminating those two transmissions for ultimately recalled transactions, the process 700 and approach set forth in this disclosure reduces the processing load of the transaction processing system 104 and reduces the number of transmissions of the subject of the transaction, each of which transmissions could be an opportunity for interception of sensitive data by third parties. Accordingly, the approach set forth in this disclosure improves both data security and the functionality of the transaction processing system 104.

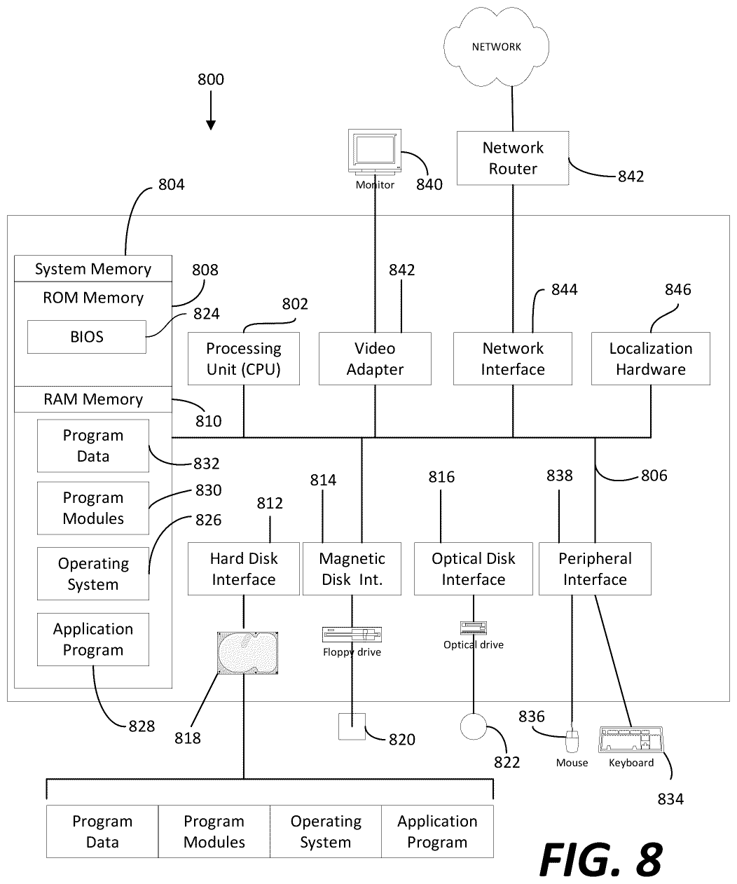

FIG. 8 is a block diagram of an example computing system 800, such as a desktop computer, laptop, smartphone, tablet, or any other such device having the ability to execute instructions, such as those stored within a non-transient, computer-readable medium. Furthermore, while described and illustrated in the context of a single computing system 800, those skilled in the art will also appreciate that the various tasks described hereinafter may be practiced in a distributed environment having multiple computing systems 800 linked via a local or wide-area network in which the executable instructions may be associated with and/or executed by one or more of multiple computing systems 800.

In its most basic configuration, computing system environment 800 typically includes at least one processing unit 802 and at least one memory 804, which may be linked via a bus 806. Depending on the exact configuration and type of computing system environment, memory 804 may be volatile (such as RAM 810), non-volatile (such as ROM 808, flash memory, etc.) or some combination of the two. Computing system environment 800 may have additional features and/or functionality. For example, computing system environment 800 may also include additional storage (removable and/or non-removable) including, but not limited to, magnetic or optical disks, tape drives and/or flash drives. Such additional memory devices may be made accessible to the computing system environment 800 by means of, for example, a hard disk drive interface 812, a magnetic disk drive interface 814, and/or an optical disk drive interface 816. As will be understood, these devices, which would be linked to the system bus 806, respectively, allow for reading from and writing to a hard disk 818, reading from or writing to a removable magnetic disk 820, and/or for reading from or writing to a removable optical disk 822, such as a CD/DVD ROM or other optical media. The drive interfaces and their associated computer-readable media allow for the nonvolatile storage of computer readable instructions, data structures, program modules and other data for the computing system environment 800. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 800.

A number of program modules may be stored in one or more of the memory/media devices. For example, a basic input/output system (BIOS) 824, containing the basic routines that help to transfer information between elements within the computing system environment 800, such as during start-up, may be stored in ROM 808. Similarly, RAM 810, hard drive 818, and/or peripheral memory devices may be used to store computer executable instructions comprising an operating system 826, one or more applications programs 828, other program modules 830, and/or program data 832. Still further, computer-executable instructions may be downloaded to the computing environment 800 as needed, for example, via a network connection. The applications programs 828 may include, for example, one or more of the risk prediction system modules, such as the entity graph module 120, the node message determination module 122, and/or the risk model module 124, in some embodiments.

An end-user may enter commands and information into the computing system environment 800 through input devices such as a keyboard 834 and/or a pointing device 836. While not illustrated, other input devices may include a microphone, a joystick, a game pad, a scanner, etc. These and other input devices would typically be connected to the processing unit 802 by means of a peripheral interface 838 which, in turn, would be coupled to bus 806. Input devices may be directly or indirectly connected to processor 802 via interfaces such as, for example, a parallel port, game port, firewire, or a universal serial bus (USB). To view information from the computing system environment 800, a monitor 840 or other type of display device may also be connected to bus 806 via an interface, such as via video adapter 832. In addition to the monitor 840, the computing system environment 800 may also include other peripheral output devices, not shown, such as speakers and printers.

The computing system environment 800 may also utilize logical connections to one or more computing system environments. Communications between the computing system environment 800 and the remote computing system environment may be exchanged via a further processing device, such a network router 842, that is responsible for network routing. Communications with the network router 842 may be performed via a network interface component 844. Thus, within such a networked environment, e.g., the Internet, World Wide Web, LAN, or other like type of wired or wireless network, it will be appreciated that program modules depicted relative to the computing system environment 800, or portions thereof, may be stored in the memory storage device(s) of the computing system environment 800.

The computing system environment 800 may also include localization hardware 846 for determining a location of the computing system environment 800. In embodiments, the localization hardware 846 may include, for example only, a GPS antenna, an RFID chip or reader, a WiFi antenna, or other computing hardware that may be used to capture or transmit signals that may be used to determine the location of the computing system environment 800.

In a first aspect of the present disclosure, a method is provided. The method includes receiving, by a computing system, data respective of an electronic transaction, the data comprising an account involved in the transaction, determining, by the computing system, an entity graph according to the account, wherein the entity graph comprises: a plurality of first-order connections, each first-order connection comprising a primary node representative of the account, a respective secondary node representative of a respective secondary entity, and a respective edge from the primary node to the secondary node, and a plurality of second-order connections, each second-order connection comprising one of the secondary nodes, a respective tertiary node representative of a respective tertiary entity, and a respective edge from the secondary node to the tertiary node. The method further includes determining, by the computing system, a respective weight associated with each first-order connection edge based on a quantity of second-order connections associated with the secondary node in the first-order connection, calculating, by the computing system, a risk associated with the electronic transaction according to the respective weights, and processing, by the computing system, the electronic transaction according to the calculated risk.

In an embodiment of the first aspect, calculating the risk associated with the electronic transaction according to the respective weights comprises calculating the risk associated with the electronic transaction according to respective feature vectors of the secondary entities. In a further embodiment of the first aspect, each feature vector comprises a plurality of respective feature values, wherein calculating the risk associated with the electronic transaction comprises applying a regression model to a combination of the feature values associated with the secondary entities, wherein the feature values are modified by the weights.

In an embodiment of the first aspect, the method further includes creating the entity graph before receiving the data respective of the electronic transaction, wherein determining the entity graph comprises retrieving a portion of the entity graph that includes the account after receiving the data respective of the electronic transaction.

In an embodiment of the first aspect, determining the entity graph is further according to one or more of a time of the transaction, a quantity of the transaction, or a category of the transaction.

In an embodiment of the first aspect, the respective weight associated with a first-order connection edge is inversely proportional to the quantity of second-order connections associated with the secondary node in the first-order connection.

In an embodiment of the first aspect, determining the entity graph according to the account comprises determining the entity graph according to a category of the account.

In a second aspect of the present disclosure, a system is provided. The system includes a processor and a non-transitory computer-readable medium having stored thereon instructions that are executable by the processor to cause the system to perform operations. The operations include receiving a request to process an electronic transaction, the electronic transaction involving a user account, and determining an entity graph according to the user account, wherein the entity graph comprises a plurality of first-order connections, each first-order connection comprising a primary node representative of the user account, a respective secondary node representative of a respective secondary entity, and a respective edge from the primary node to the secondary node, and a plurality of second order connections, each second-order connection comprising one of the secondary nodes, a respective tertiary node representative of a respective tertiary entity, and a respective edge from the secondary node to the tertiary node. The operations further include determining a respective weight associated with each first-order connection edge and processing the electronic transaction according to values associated with characteristics of the secondary entities, wherein the values are modified by the weights.

In an embodiment of the second aspect, the operations further include creating the entity graph before receiving the data respective of the electronic transaction, wherein determining the entity graph comprises retrieving a portion of the entity graph that includes the user account after receiving the request to process the electronic transaction.

In an embodiment of the second aspect, an edge from the primary node to a secondary node is indicative of a common behavior associated with the user account and the secondary entity associated with the secondary node.

In an embodiment of the second aspect, processing the electronic transaction according to values associated with characteristics of the secondary entities, wherein the values are modified by the weights, comprises applying a regression model to the values modified by the weights.

In an embodiment of the second aspect, the user account comprises one or more of an account of a providing user in the transaction, or an account of a receiving user in the transaction.

In an embodiment of the second aspect, processing the electronic transaction according to the values associated with characteristics of the secondary entities, wherein the values are modified by the weights, includes determining that a risk associated with the electronic transaction, the risk based on the values associated with the characteristics of the secondary entities, wherein the values are modified by the weights, exceeds a threshold, in response to determining that the risk exceeds the threshold, delaying processing of a portion of the transaction for a predetermined period of time.

In an embodiment of the second aspect, the respective weight associated with a first-order connection edge is inversely proportional to the quantity of second-order connections associated with the secondary node in the first-order connection.

In a third aspect of the present disclosure, a method is provided that includes receiving, by a computing system, a request to process an electronic transaction, the electronic transaction comprising an account, determining, by the computing system, an entity graph according to the account, wherein the entity graph comprises a plurality of first-order connections, each first-order connection comprising a primary node representative of the account, a respective secondary node representative of a respective secondary entity, and a respective edge from the primary node to the secondary node, and a plurality of second order connections, each second-order connection comprising one of the secondary nodes, a respective tertiary node representative of a respective tertiary entity, and a respective edge from the secondary node to the tertiary node. The method further includes determining, by the computing system, a respective weight associated with each first-order connection edge based on a cardinality of the secondary node in the first-order connection, calculating, by the computing system, a risk associated with the electronic transaction according to the respective weights, determining, by the computing system, that the risk exceeds a threshold and, in response, processing a first portion of the electronic transaction, and delaying processing of a second portion of the electronic transaction.

In an embodiment of the third aspect, the method includes determining, after a predetermined passage of time after processing the first portion of the transaction, that the transaction has not been recalled, and in response to determining that the transaction has not been recalled, processing the second portion of the transaction.

In an embodiment of the third aspect, the cardinality of the secondary node is based on a quantity of second-order connections of the secondary node.

In an embodiment of the third aspect, the method further includes determining, within a predetermined period of time after processing the first portion of the transaction, that the transaction has been recalled, and in response to determining that the transaction has not been recalled, not processing the second portion of the transaction, and reversing the processing of the first portion of the transaction.

In an embodiment of the third aspect, calculating the risk associated with the electronic transaction comprises applying a regression model, according to the weights, to two or more of a feature of the account, a time of the transaction, a quantity of the transaction, a category of the transaction, a characteristic of a providing user in the transaction, or a characteristic of a receiving user in the transaction.

In an embodiment of the third aspect, the method further includes amending a feature vector associated with the account according to the second portion of the transaction, and amending a respective feature vector of with one or more secondary nodes according to the second portion of the transaction.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method comprising:
receiving, by a computing system, data respective of an electronic transaction, the data comprising an account involved in the transaction;
determining, by the computing system, an entity graph according to the account, wherein the entity graph comprises:
a plurality of first-order connections, each first-order connection comprising a primary node representative of the account, a respective secondary node representative of a respective secondary entity, and a respective edge from the primary node to the secondary node; and
a plurality of second-order connections, each second-order connection comprising one of the secondary nodes, a respective tertiary node representative of a respective tertiary entity, and a respective edge from the secondary node to the tertiary node;
determining, by the computing system, a respective weight associated with each first-order connection edge based on a quantity of second-order connections associated with the secondary node in the first-order connection;
calculating, by the computing system, a risk associated with the electronic transaction according to the respective weights; and
processing, by the computing system, the electronic transaction according to the calculated risk.

2. The method of claim 1, wherein calculating the risk associated with the electronic transaction according to the respective weights comprises calculating the risk associated with the electronic transaction according to respective feature vectors of the secondary entities.

3. The method of claim 2, wherein each feature vector comprises a plurality of respective feature values, wherein calculating the risk associated with the electronic transaction comprises applying a regression model to a combination of the feature values associated with the secondary entities, wherein the feature values are modified by the weights.

4. The method of claim 1, further comprising:
creating the entity graph before receiving the data respective of the electronic transaction;
wherein determining the entity graph comprises retrieving a portion of the entity graph that includes the account after receiving the data respective of the electronic transaction.

5. The method of claim 1, wherein determining the entity graph is further according to one or more of:
a time of the transaction;
a quantity of the transaction; or
a category of the transaction.

6. The method of claim 1, wherein the respective weight associated with a first-order connection edge is inversely proportional to the quantity of second-order connections associated with the secondary node in the first-order connection.

7. The method of claim 1, wherein determining the entity graph according to the account comprises determining the entity graph according to a category of the account.

8. A system comprising:
a processor; and
a non-transitory computer-readable medium having stored thereon instructions that are executable by the processor to cause the system to perform operations comprising:
receiving a request to process an electronic transaction, the electronic transaction involving a user account;
determining an entity graph according to the user account, wherein the entity graph comprises:
a plurality of first-order connections, each first-order connection comprising a primary node representative of the user account, a respective secondary node representative of a respective secondary entity, and a respective edge from the primary node to the secondary node; and
a plurality of second order connections, each second-order connection comprising one of the secondary nodes, a respective tertiary node representative of a respective tertiary entity, and a respective edge from the secondary node to the tertiary node;
determining a respective weight associated with each first-order connection edge; and
processing the electronic transaction according to values associated with characteristics of the secondary entities, wherein the values are modified by the weights.

9. The system of claim 8, wherein the operations further comprise:
creating the entity graph before receiving the request to process the electronic transaction;
wherein determining the entity graph comprises retrieving a portion of the entity graph that includes the user account after receiving the request to process the electronic transaction.

10. The system of claim 8, wherein an edge from the primary node to a secondary node is indicative of a common behavior associated with the user account and the secondary entity associated with the secondary node.

11. The system of claim 8, wherein processing the electronic transaction according to values associated with characteristics of the secondary entities, wherein the values are modified by the weights, comprises applying a regression model to the values modified by the weights.

12. The system of claim 8, wherein the user account comprises one or more of:
an account of a providing user in the transaction; or
an account of a receiving user in the transaction.

13. The system of claim 8, wherein processing the electronic transaction according to the values associated with characteristics of the secondary entities, wherein the values are modified by the weights, comprises:
determining that a risk associated with the electronic transaction, the risk based on the values associated with the characteristics of the secondary entities, wherein the values are modified by the weights, exceeds a threshold;
in response to determining that the risk exceeds the threshold, delaying processing of a portion of the transaction for a predetermined period of time.

14. The system of claim 8, wherein the respective weight associated with a first-order connection edge is inversely proportional to a quantity of second-order connections associated with the secondary node in the first-order connection.

15. A method comprising:
receiving, by a computing system, a request to process an electronic transaction, the electronic transaction comprising an account;
determining, by the computing system, an entity graph according to the account, wherein the entity graph comprises:
a plurality of first-order connections, each first-order connection comprising a primary node representative of the account, a respective secondary node representative of a respective secondary entity, and a respective edge from the primary node to the secondary node; and
a plurality of second order connections, each second-order connection comprising one of the secondary nodes, a respective tertiary node representative of a respective tertiary entity, and a respective edge from the secondary node to the tertiary node;
determining, by the computing system, a respective weight associated with each first-order connection edge based on a cardinality of the secondary node in the first-order connection;
calculating, by the computing system, a risk associated with the electronic transaction according to the respective weights;
determining, by the computing system, that the risk exceeds a threshold and, in response:
processing a first portion of the electronic transaction; and
delaying processing of a second portion of the electronic transaction.

16. The method of claim 15, further comprising:
determining, after a predetermined passage of time after processing the first portion of the transaction, that the transaction has not been recalled; and
in response to determining that the transaction has not been recalled, processing the second portion of the transaction.

17. The method of claim 15 wherein the cardinality of the secondary node is based on a quantity of second-order connections of the secondary node.

18. The method of claim 15, further comprising:
determining, within a predetermined period of time after processing the first portion of the transaction, that the transaction has been recalled; and
in response to determining that the transaction has not been recalled:
not processing the second portion of the transaction; and
reversing the processing of the first portion of the transaction.

19. The method of claim 15, wherein calculating the risk associated with the electronic transaction comprises applying a regression model, according to the weights, to two or more of:
a feature of the account;
a time of the transaction;
a quantity of the transaction;
a category of the transaction;
a characteristic of a providing user in the transaction; or
a characteristic of a receiving user in the transaction.

20. The method of claim 15, further comprising:
amending a feature vector associated with the account according to the second portion of the transaction; and
amending a respective feature vector of with one or more secondary nodes according to the second portion of the transaction.
